(19) United States
(12) Patent Application Publication
(10) Pub. No.: US 2006/0043200 A1
(43) Pub. Date: Mar. 2, 2006

(54) Chip card module

(75) Inventors: Frank Puschner, Kelheim (DE); Peter Stampka, Burglengenfeld (DE); Andreas Muller-Hipper, Regensburg (DE); Wolfgang Schindler, Regenstauf (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/211,167

(22) Filed: Aug. 23, 2005

(30) Foreign Application Priority Data
Aug. 31, 2004 (DE) 10 2004 042 187.0

(51) Int. Cl. G06K 19/06

(52) U.S. Cl. 235/492

(57) ABSTRACT

A chip card module for a contactless chip card having a chip containing an integrated circuit, and having a coupling element, electrically connected to the chip to permit contactless communication. The chip card module has a layer sequence formed on a surface side of the chip card module, with a first layer reflecting electromagnetic waves, a second layer arranged on this first layer, and a third layer, in which a metallic cluster is embedded, arranged on the second layer.

### CROSS-REFERENCE TO RELATED APPLICATION

This application claims priority to German Patent Application Serial No. 102004042187.0, which was filed Aug. 31, 2004 and is incorporated herein by reference in its entirety.

### FIELD OF THE INVENTION

The invention relates to a chip card module for a contactless chip card, having a chip, containing an integrated circuit, and having a coupling element, electrically connected to the chip to permit contactless communication.

### BACKGROUND OF THE INVENTION

Chip cards have long been known and are increasingly used for example as phone cards, identity cards or the like. Contactless chip cards communicate with a read/write unit via an electromagnetic field. An electromagnetic field is in this case generated in the read/write unit, its modulation allowing data to be transferred to a chip card which is located in this field in adequate proximity to the read/write unit. For this purpose, the chip card is equipped with a coupling element, for example a loop antenna. A modulation of the field brings about changes in the voltage induced in the loop antenna or in the current caused as a result. For the transmission of data in the opposite direction, that is to say from the chip card to the read/write unit, a load modulation is used for example. In this case, a load connected in parallel with the antenna on the chip card is varied, so that varying amounts of energy are drawn from the electromagnetic field in a way corresponding to the load changes. This can be detected by the read/write unit and converted into a data signal.

Contactless chip cards are often set up in such a way that they also draw the electrical power required for their operation from the electromagnetic field of the read/write unit. A battery or the like is therefore not required.

One advantage of contactless chip cards is that no susceptible mechanical contacts are required. Moreover, the communication can take place without a direct contact being established between the contactless chip card and the read/write unit. In the case of typical contactless chip card systems, trouble-free communication can take place if the distance between the read/write unit and the chip card is less than 1 m. With the increasing significance of chip cards, it is increasingly important to prevent misuse. Misuse may take place in particular by forged chip cards being used. While in the case of chip cards with contacts it is possible at least in the case of some applications for a check to be carried out on the persons using them, for example by keeping an ATM under video surveillance, it is more difficult in the case of contactless chip cards, since they sometimes even operate from relatively great distances. Moreover, in the case of contactless chip cards, there is no optical checking of the card, so that misuse cannot be detected and prevented by optical scanning of security features on the chip card.

WO 97/33252 discloses for example a method for checking the authenticity of documents in the form of chip cards. In this case, foreign bodies are embedded in a base material from which the card is produced, these foreign bodies being randomly distributed in the base material. When the document is issued, the card is scanned for foreign bodies by a detector on a scanning track selected by a random generator. After that, the output values of the detector are stored in the chip of the chip card, the memory area not allowing itself to be read or manipulated from the outside. When the document prepared in this way is used, the foreign body information is read by at least one detector of the terminal receiving the document and is compared with the foreign body information in the register. If it matches, the document is released.

A disadvantage of this known method is that, for it to be applied in the case of contactless chip cards, the chip card must in turn be brought into direct contact with the read/write unit, in order that a detector can pick up the foreign particle information.

### SUMMARY OF THE INVENTION

An object of the invention is to provide a contactless chip card or chip card module for a contactless chip card which can be distinguished from manipulated chip cards or chip card modules or from forgeries of chip cards or chip card modules.

This object is achieved by a chip card module of the type mentioned at the beginning, wherein a layer sequence is formed on a surface side of the chip card module, with a first layer, reflecting electromagnetic waves, a second layer, arranged on this first layer, and a third layer, in which a metallic cluster is embedded, arranged on the second layer.

### BRIEF DESCRIPTION OF THE DRAWINGS

The invention is explained in more detail below on the basis of an exemplary embodiment. In the drawing:

FIG. 1 shows a first exemplary embodiment of a chip card module according to the invention;

FIGS. 2 and 3 show detailed representations of the layer sequence 5 from FIG. 1;

FIG. 4 shows a second exemplary embodiment of the chip card module according to the invention;

FIG. 5 shows an arrangement with a reader for determining characteristics and a chip card module as shown in FIG. 1;

FIG. 6 shows a diagram with two characteristics, which have been recorded by the arrangement from FIG. 5;

FIG. 7 shows the invention of the chip card module from FIG. 1 in a chip card; and

FIG. 8 shows the use of a chip card module according to FIG. 3 in a chip card.

### DETAILED DESCRIPTION OF PREFERRED EMBODIMENTS OF THE INVENTION

The present invention is directed to a chip card module wherein a layer sequence is formed on a surface side of the chip card module, with a first layer, reflecting electromagnetic waves, a second layer, arranged on this first layer, and a third layer, in which a metallic cluster is embedded, arranged on the second layer.

A first advantage of the chip card module according to the invention for contactless chip cards is that the layer sequence produces an individual marking, which is independent of the card in which a chip card module is received. This prevents a forged chip card module being inserted in the “genuine” card. The planned misuse of chip cards can be discovered already when chip card modules are brought into circulation, so that countermeasures can be taken at an early stage. Use of the chip card module forgery cannot be concealed by subsequent manipulations of a card body in which the forged chip card modules are inserted.

The use according to the invention of a layer sequence, with a first layer, reflecting electromagnetic waves, a second layer, arranged on this first layer, and a third layer, in which a metallic cluster is embedded, arranged on the second layer, permits forgery-proof marking of a chip card module, even if it is very small. Such a layer sequence has strong, narrowband reflection minima, the spectral positions of which depend extremely sensitively on the spatial arrangement of the metallic cluster elements, in particular the distance from the first, electromagnetic wave-reflecting layer. In other words, each individual layer sequence has a uniquely assignable color characteristic.

If the color characteristic is determined from different angles, color characteristics that deviate considerably from one another are obtained. Consequently, any desired number of color characteristics specific to a chip module can be produced from a single layer sequence. In a favorable refinement of the invention, these characteristics are stored in the chip of the chip card module. This allows the authenticity to be checked throughout the entire service life of the chip card module, by comparing measured characteristics with the stored characteristics.

When individual characteristics are stored outside the chip module, it is possible when later checking the chip card modules to discover on the basis of the characteristics stored in the chip or newly measured characteristics whether they match with chip card modules intentionally brought into circulation. This is particularly important in the case of products relevant to security, such as passports or personal identity documents. If, for example, when a passport is issued, the characteristic is stored, it can later be discovered whether a passport has actually been issued by the official authority specified or it is a forgery. In this respect, it is particularly advantageous that a comparison of the externally stored characteristics with the characteristics stored in the chip 3 can take place contactlessly, without a close spatial distance being required, as in the case of optical scanning of a security feature.

The chip card module according to the invention consequently has a dual security function. On the one hand, by detection of the individual characteristics of a layer sequence of a chip card module and comparison with the characteristics stored in the chip, it can be discovered whether the layer sequence and the chip belong together. This makes it possible to detect whether subsequent manipulations have been carried out on a marked chip. On the other hand, the origin of the chip can be traced at any time, so that it can be discovered whether a chip card module actually originates from a reliable source.

It is favorable if the layer sequence is arranged on the chip. If a leadframe is used for the electrical connection of the chip to the coupling element, it is also advantageous to arrange the layer sequence on the leadframe.

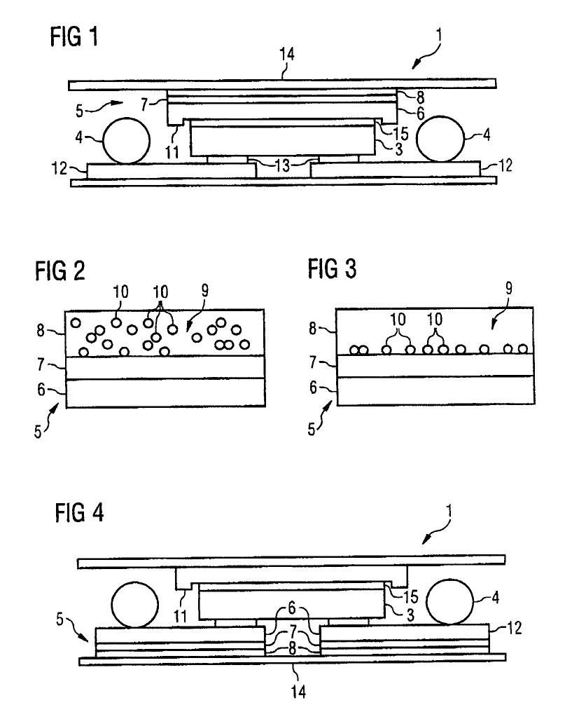

FIG. 1 shows a chip card module 1 according to the invention in a schematic representation. This module has a chip 3, containing an integrated circuit. Provided on its underside are two contact areas 13, by which the chip 3 is electrically and mechanically connected to a leadframe 12. Arranged on the side of the chip 3 facing away from the leadframe 12 is a layer sequence 5, which in the exemplary embodiment of FIG. 1 comprises a stiffening element 11, which forms a first layer 6, reflecting electromagnetic waves, a second layer 7 and a third layer 8, in which a metallic cluster 9 is embedded. If a stiffening element 11, which can be used as the first layer 6, is not provided, the first layer 6 may also be realized by a thin metallic coating or other measures that produce electromagnetic wave-reflecting properties.

The property of reflecting electromagnetic waves of the stiffening element 11 is achieved by the stiffening element 11 being produced from an electrically conducting material. The second layer 7 is provided in order to ensure a defined minimum distance between the first layer 6 and cluster elements 10 in the third layer 8. Above the layer sequence 5 there may be arranged a protective layer, which however must be permeable to the electromagnetic waves that are used, in order that they can reach the layer sequence 5. If visible light is used, the protective layer must therefore be a transparent material. The protective layer may also be added at a later point in time in the production process, once the chip card module has been inserted into a card. In this case, the protective layer is formed for example by a transparent film 14, which is placed over the entire chip card surface.

The connection between the chip 3 and the stiffening element 11 is established in the exemplary embodiment shown in FIG. 1 by an adhesive layer 15. On the underside of the chip card module 1, a transparent film is in turn provided, corresponding to the film used on the upper side. However, this film does not have to be transparent, since it has no significance for the function of the layer sequence 5. It is therefore sufficient for the region of the card body or the outer film lying over the layer sequence to be transparent.

The leadframe 12 is connected to a loop antenna 4, two windings being represented in FIG. 1. A first winding is connected to the portion of the leadframe 12 that is represented on the left, while another winding is connected to the portion of the leadframe 12 that is represented on the right. Further windings of the loop antenna are not represented in FIG. 1.

In FIGS. 2 and 3, a more detailed, schematic representation of the layer sequence 5 in the various embodiments is shown. It can be seen here that a cluster 9 comprising a multiplicity of cluster elements 10 is formed in the third layer 8. In FIG. 2, these are randomly distributed within the layer 8, while in FIG. 3 they are arranged at the layer boundary between the second layer 7 and the third layer 8. The second layer 7 is arranged under the third layer 8 and the first layer 6 is in turn arranged thereunder. The second layer 7 produces a minimum distance between the first layer 6 and the cluster elements 10 in the third layer 8.

The mode of operation of such a layer arrangement is based on the resonance amplification of the clusters, in which the clusters interact with their mirror dipoles, so that the arrangement of the cluster elements is transformed into an easily measurable optical signal. In particular in the case of very small cluster diameters, such layer arrangements have narrowband reflection minima, the spectral positions of which depend extremely sensitively on the spatial arrangement of the metallic cluster elements, in particular the distance from the reflecting surface. The layer sequence can transform even the slightest differences in the arrangement of the cluster elements into a clearly detectable optical signal, which can be detected for example from a spectral shift of the absorption maximum.

The electromagnetic wave-reflecting layer is preferably formed by a metallic layer, it is to say an electrically conductive layer. In addition, however, it is also conceivable to use what is known as a Bragg mirror, which has very good reflection properties without being electrically conductive.

The physical mode of operation is described in detail below on the basis of a metallic first layer. A metallic cluster, which lies at a defined distance from a metallic surface, interacts electrodynamically with the neighboring metal layer. With a defined distance of the absorbent cluster layer from the metal surface, the electric field which is “thrown back” from the metal surface comes to lie in the same phase as the incident electromagnetic wave. The resultant superposing intensifies the effective absorption coefficient of the cluster layer. Since, with a given layer thickness of the second layer 7, the optimum phase gain depends only on the frequency of the irradiated light, the system can be defined by narrow and strong reflection minima. The intensity of the absorption is directly proportional to the number of cluster elements in a wider region of coverage with cluster elements. In cases of high surface coverage, a spectral shift additionally occurs as a result of cluster-cluster interactions. The optical behavior of the layer sequence can be described by what is known as the Stratified Medium theory or the CPS theory. These theories are based either on the behavior of an optical thin film on the behavior of a polarized particle near a metal surface.

The cluster elements preferably consist of chromium. This has on the one hand favorable chemical and electrical properties and is on the other hand relatively inexpensive. However, other metallic materials may also be used, such as for example gold. The distribution of the cluster elements 10 may be based on a specific pattern or else the cluster elements may be added in such a way that a random distribution is obtained. In order to arrange the cluster elements, as represented in FIG. 3, at the layer boundary between the second layer 7 and the third layer 8, it is possible to proceed in production in such a way that the cluster elements are applied with a suitable adhesive material on the second layer 7. After that, a covering layer is applied, covering over the cluster elements 10. If the same material is used for the adhesive material and the covering material, a unitary layer is obtained.

For the formation of the first layer 6, which has reflecting properties, not only the above-mentioned metallically conductive layers and Bragg mirrors can be used but also a second cluster.

The achieved absorption behavior of the layer sequence makes it appear colored if the wavelength of the irradiated electromagnetic waves lies in the visible range, in other words the electromagnetic wave is also light in the visible range.

The absorption behavior of the layer sequence 5 depends strongly on the angle of the incident light. At different angles of incidence, therefore, different characteristics of the reflection/absorption behavior are also obtained.

In FIG. 4, a second exemplary embodiment of a chip card module according to the invention is represented. In the case of this exemplary embodiment, a different surface side was chosen for the arrangement of the layer sequence 5. Since a leadframe 12 is used in the case of the chip card module represented in order to establish the contacting between the chip 3 and the coupling elements 4, suitable areas are available on the side of the leadframe 12 that is facing away from the chip 3. It is advantageous here that the leadframe 12 is a metallic layer, so that this can at the same time form the electromagnetic wave-reflecting first layer 6. In the exemplary embodiment shown, a layer sequence 5 has been applied on a number of regions of the leadframe 12. It goes without saying that it would be sufficient to provide it on only one region of the leadframe.

In the case of the arrangement of FIG. 4, it should be noted that a further layer under the layer sequence 5, for example a protective layer, consists of a material which is permeable to the electromagnetic waves that are used, that is to say is transparent if visible light is used.

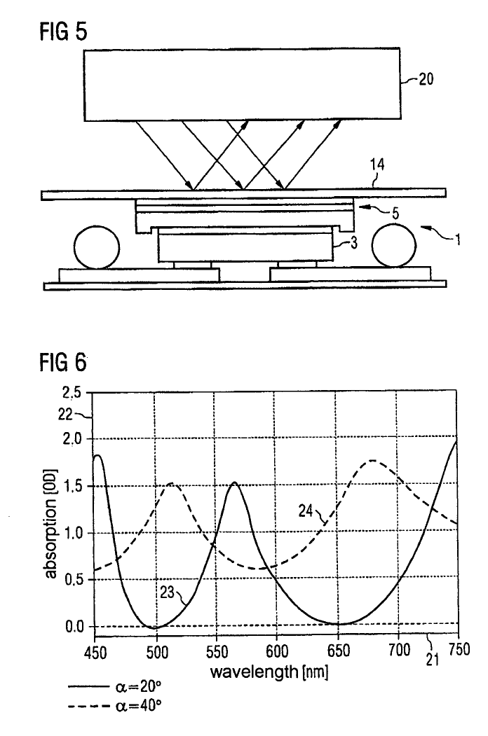

FIG. 5 shows an arrangement with a chip card module 1 according to the invention and a detector 20. If such an arrangement is used, the reflection/absorption behavior of the layer sequence 5 can be measured. The incident light is reflected, different spectral ranges being absorbed to differing degrees. This produces a characteristic such as that represented in FIG. 6. There, the absorption is represented on the axis 22 with respect to the wavelength plotted on the axis 21. The characteristic 23 was recorded at an angle of incidence of 20°, while the characteristic 24 was recorded at an angle of incidence of 40°. To be able to record a number of characteristics, it is of advantage if the detector 20 can emit light at different angles. Alternatively, the relative position of the chip card module 1 with respect to the detector 20 is changed. The more characteristics are recorded, the more parameters are available for an authenticity check.

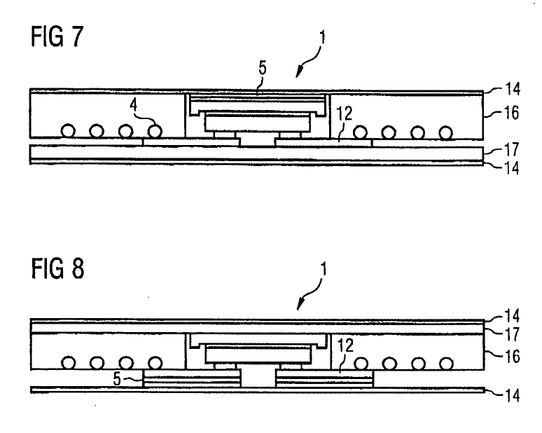

FIGS. 7 and 8 show chip cards in which a chip card module according to the invention as shown in FIG. 1 or as shown FIG. 3 is fitted. In the case of FIG. 7, the chip card module as shown in FIG. 1 was used. It can be seen that the layer 14 shown in FIG. 1 as a protective layer—in the case shown it is an outer film—extends over the entire card body. The card body itself has a layer structure. Provided between the two outer films 14, which consist for example of a PE material, is a paper layer 16. In this layer 16, or between the paper layer 16 and a carrier film 17, lie the windings of a loop antenna 4. The leadframe 12 of the chip card module 1 is connected to the carrier film 17, which preferably likewise consists of a PE material. In the selection of the outer film 14, it must be ensured that, at least in the portion above the layer sequence 5, it is permeable to the electromagnetic waves that are used, that is to say transparent in the case of light.

In the case of the arrangement of FIG. 8, the carrier film 17 is arranged above the chip, so that the chip card module 1 is connected to the carrier film 17 via a stiffening element 11. This is necessary because the layer sequence 5 which realizes the individual marking is formed on the undersides of the leadframe 12. In this case, the outer film 14 must be transparent in the region of the leadframe 12.

In the storage of the characteristics determined, it may be advantageous if the data are stored in the chip 3 in encrypted form, so that increased security is obtained. Security is further increased if the comparison between the stored data and the data measured later takes place within the chip 3, so that the stored data do not leave the chip 3 as such. This rules out further possibilities of manipulation.

As a departure from the connections of the chip 3 to the coupling elements 4 via a leadframe that are represented in FIGS. 1 and 3, it goes without saying that other connecting techniques can also be used, for example a connection of the contact areas 13 to contact areas of a carrier via wire bonding connections. The chip 3 could also be connected to a carrier by means of a flip-chip connection. In the case of such refinements, there is the possibility of arranging the layer sequence 5 on the side of the carrier that is facing away from the chip.

What is claimed is:

1. A chip card module for a contactless chip card having a chip containing an integrated circuit, and a coupling element, electrically connected to the chip to permit contactless communication, the chip card module comprising:
a layer sequence, which is formed on a surface side of the chip card module, having:
a first layer, reflecting electromagnetic waves;
a second layer, arranged on this first layer; and
a third layer, in which a metallic cluster is embedded, arranged on the second layer.

2. The chip card module of claim 1, wherein the embedding of the cluster is formed such that the cluster elements lie at the layer boundary between the second and third layers.

3. The chip card module of claim 1, wherein the embedding of the cluster is formed such that the cluster elements are arranged in a specific pattern within the third layer.

4. The chip card module of claim 1, wherein the embedding of the cluster is formed such that the cluster elements are randomly distributed within the third layer.

5. The chip card module of claim 1, wherein an adhesion promoting layer is arranged between the first layer and the second layer.

6. The chip card module of claim 1, wherein the first layer is a Bragg mirror.

7. The chip card module of claim 1, wherein the first layer is a further metallic cluster.

8. The chip card module of claim 1, wherein the cluster elements are formed from chromium.

9. The chip card module of claim 1, wherein the cluster elements are formed from gold.

10. The chip card module of claim 1, wherein individual parameters of the reflection behavior of the layer sequence are stored in the chip.

11. The chip card module of claim 1, wherein the layer sequence is arranged on the chip.

12. The chip card module of claim 11, wherein a metallic stiffening element, which forms the first layer, is arranged on the chip.

13. The chip card module of claim 1, wherein the electrical connection between the chip and the coupling element takes place by means of a leadframe and the layer sequence is arranged on the leadframe.

14. A chip card having the chip card module of claim 1 comprising a first transparent card surface portion, wherein the layer sequence of the chip card module is arranged in the region of the transparent card surface portion.
